(19) United States
(12) Patent Application Publication
(10) Pub. No.: US 2010/0231115 A1
(43) Pub. Date: Sep. 16, 2010

(54) IMAGE DISPLAYING APPARATUS

(75) Inventor: Kinya Kamiguchi, Kamakura-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/722,933

(22) Filed: Mar. 12, 2010

(30) Foreign Application Priority Data
Mar. 13, 2009 (JP) 2009-061341

(51) Int. Cl. H01J 5/50

(52) U.S. Cl. 313/331

(57) ABSTRACT

A connector, which is fixed to an outer surface of an airtight container and connects a cable and an electrode terminal to each other, comprises a base member fixed to the outer surface of the airtight container and wherein a pointed end of the electrode terminal extends up to the inside of the base member, a cap member having a cable insertion portion wherein one end of the cable has been inserted and fixed to the base member, and a conductive member held between the base member and the cap member. The conductive member has a first portion being in contact with the inserted cable and a second portion being in contact with the pointed end of the electrode terminal, and the first portion and the second portion are located at positions mutually different on the same plane which is in parallel with the contact surface of the base member.

### BACKGROUND OF THE INVENTION

1. Field of the Invention

The present invention relates to an image displaying apparatus. In particular, the present invention relates to an image displaying apparatus which is equipped with a flat display panel in which a high-voltage anode electrode is provided on a face plate and a connector for regulating potential of the anode electrode is provided on a rear plate.

2. Description of the Related Art

In a conventional image displaying apparatus such as a CRT (cathode ray tube) or the like to which high potential is applied, a special connector which has been designed with insulation measures is used (see Japanese Patent Application Laid-Open Nos. 2006-294324 and 2007-200567). This connector has a base member which is attached to the surface of an airtight container constituting a display panel so as to hold a high-voltage electrode terminal. Further, this connector has a cap member which is attached to the base member so as to hold a high potential supplying cable extending from a power supply provided outside the display panel. Here, since a conductive member is provided between the base member and the cap member, the cable and the electrode terminal are electrically connected to each other by means of the conductive member. Each of the base member and the cap member has a concentric groove/rib structure. Therefore, if the groove/rib structures of the base member and the cap member are interdigitated each other, the base member and the cap member are mutually positioned and mutually fixed to each other. Since the conductive member is held at the location in the vicinity of the center of the connector, a long creepage distance of insulation by the interdigitated groove/rib structures can be secured. Thus, the connector which has high insulation performance can be achieved.

In recent years, a flat panel image displaying apparatus which uses a display panel using surface conduction electron-emitting devices and field emission electron-emitting devices has been known. In this display panel, an anode electrode is provided on a face plate acting as an image displaying unit and the electron-emitting devices are provided on a rear plate. Further, the face plate and the rear plate are sealed and bonded at their peripheries, and an airtight container of which the inside has been airtightly sealed is thus constituted, whereby the anode electrode and the electron-emitting devices are resultingly provided inside the airtight container. High potential is applied to the anode electrode. Here, since the high potential is supplied through an electrode terminal which is provided so as to penetrate the rear plate, the high potential supplied from an external power supply is applied to the anode electrode through the connector provided on the back (that is, the surface on the other side of the surface opposite to the face plate) of the rear plate.

In any case, since the connector is provided so as to project from the rear plate, it is important to reduce the height of the connector (that is, the dimension of the portion projecting from the rear plate) for the purpose of thinning the display panel. However, the electrode terminal projects outward from the inside of the display panel in the direction perpendicular to the rear plate (that is, the electrode terminal penetrates the rear plate in the direction perpendicular to the back of the rear plate). For this reason, in regard to the conventional connector, the electrode terminal and the cable are connected to each other in the direction perpendicular to the outer surface of the rear plate in conformity with the projecting direction of the electrode terminal.

### SUMMARY OF THE INVENTION

Consequently, since there is a limit in reduction of the height of the connector, new measures are needed.

In consideration of such a problem in the related background art, the present invention aims, in a display panel in which a high-voltage anode electrode is provided on a face plate and a connector for regulating potential of the anode electrode is provided on a rear plate, to reduce the height of the connector.

According to one aspect of the present invention, a display panel comprises: an airtight container; an electrode terminal which penetrates an outer surface of the airtight container and is adapted to supply potential to an electrode provided inside the airtight container; a cable which has a portion extending along the outer surface of the airtight container and is connected to a power supply generating the potential; and a connector which is fixed to the outer surface of the airtight container and is adapted to connect the cable and the electrode terminal to each other. Further, the connector comprises: a base member which is fixed to the outer surface of the airtight container, and in which a part of the electrode terminal penetrates an aperture provided on a contact surface of the base member being in contact with the outer surface of the airtight container and a pointed end of the electrode terminal extends up to the inside of the base member; a cap member which has a cable insertion portion in which one end of the cable has been inserted, and is fixed to the base member; and a conductive member which includes a first portion held between the base member and the cap member and being in contact with the inserted cable and a second portion being in contact with the pointed end of the electrode terminal. Furthermore, the first portion and the second portion are positioned separately on the same plane which is in parallel with the contact surface.

The first portion which is in contact with the cable and the second portion which is in contact with the pointed end of the electrode terminal are located at the positions mutually different on the same plane which is in parallel with the contact surface. For this reason, in the connector according to the present invention, the connection between the electrode terminal and the cable can be achieved on the plane which is in parallel with the rear plate. By such a constitution of the connector, it is possible to easily reduce the height of the connector.

As just described, according to the present invention, in the display panel in which the high-voltage anode electrode is provided on the face plate and the connector for regulating the potential of the anode electrode is provided on the rear plate, it is possible to reduce the height of the connector.

Other features and advantages of the present invention will be apparent from the following description when taken in conjunction with the accompanying drawings, in which like reference characters designate the same or similar parts throughout the figures thereof.

### BRIEF DESCRIPTION OF THE DRAWINGS

FIG. 1 is a schematic cross sectional view of an image displaying apparatus.

FIGS. 2A, 2B and 2C are cross sectional views of a connector fixed to an airtight container.

FIG. 3 is a disassembled perspective view of the connector illustrated in FIGS. 2A to 2C.

FIG. 4 is a perspective view of a base member illustrated in FIGS. 2A to 2C and FIG. 3.

FIGS. 5A and 5B are perspective views of a cap member illustrated in FIGS. 2A to 2C and FIG. 3.

FIG. 6 is a perspective view of a conductive member illustrated in FIGS. 2A to 2C and FIG. 3.

### DESCRIPTION OF THE EMBODIMENTS

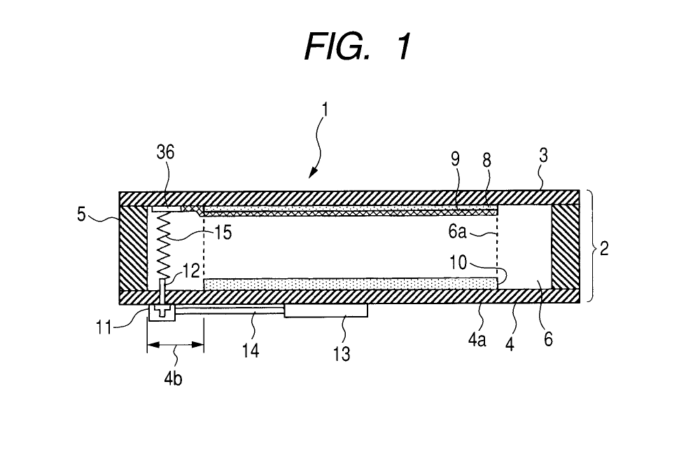

Hereinafter, the exemplary embodiment of an image displaying apparatus of the present invention will be described with reference to the attached drawings. FIG. 1 is a schematic cross sectional view of the image displaying apparatus according to the embodiment of the present invention.

An airtight container 2 of an image displaying apparatus 1 has a first substrate (face plate) 3 and a second substrate (rear plate) 4 arranged oppositely each other and a frame member 5 positions between these substrates. These substrates 3 and 4 and the frame member 5 are formed by, for example, a glass and bonded each other by a bonding member (not illustrated) having a sealing function such as a frit or the like to form an internal space 6 maintained to have such the pressure lower than atmospheric pressure. The first substrate 3 has a fluorescent film 8 and an anode electrode 9 which covers the fluorescent film 8, and the second substrate 4 has an electron-emitting portion 10. The phosphors of red, green and blue are arranged, for example, in matrix on the fluorescent film 8, and the anode electrode 9 is composed of a conductive film such as Al or the like. The electron-emitting portion 10 has plural electron-emitting devices (not illustrated) arranged in matrix respectively connected with plural column directional wirings (not illustrated) and plural row directional wirings (not illustrated). As the electron-emitting devices, field emission electron-emitting devices such as MIM (Metal Insulator Metal) electron-emitting devices, surface conduction electron-emitting devices or the like can be used. When operating the electron-emitting device, electrons are emitted from the electron-emitting devices in accordance with an image signal. The anode electrode 9 accelerates the electrons emitted from the electron-emitting devices so as to collide with the fluorescent film 8 so that the fluorescent film 8 emits the light. The anode electrode 9 can have a function of a metal back and can also reflect the light proceeding to the electron-emitting portion 10 from the fluorescent film 8 toward the direction of the first substrate 3.

A power supply 13 for generating high potential at a level from several hundreds volts (V) to several tens kilovolts (kV) can be also provided on an outer surface (an atmospheric side surface) 4a of the second substrate 4, however the power supply 13 can be provided apart from the airtight container 2. The airtight container 2 and the power supply 13 are held inside the one housing. Incidentally, a driver circuit or a power supply for supplying potential to the driver circuit are also held inside the housing other than the airtight container 2 and the power supply 13. The power supply 13 has such the constitution equivalent to that of a power supply, which includes a flyback transformer or the like, to be used in a conventional CRT image displaying apparatus. A whole part of a cable 14 (wiring) connected to the power supply 13 is illustrated in a form of extending along the outer surface 4a of the second substrate 4 in FIG. 1, however it is allowed that at least a part of the cable (a portion inserted in a connector) is in a form of extending along the outer surface 4a of the second substrate 4. An electrode terminal 12 penetrates the outer surface 4a of the airtight container 2 from the internal space 6 of the airtight container 2 to be extended. In other words, the electrode terminal 12 penetrates the second substrate 4. The electrode terminal 12 is connected to one end of a conductive resilient member 15 which extends by intersecting the internal space 6, that is, a space between the first substrate 3 and the second substrate 4. The electrode terminal 12 can be constituted by a conductive bar (pin) composed of the conductive material such as Ag, Cu, Ni—Co alloy or the like. The resilient member 15 is connected to an extraction wiring 36 composed of Ag or the like at other end of the resilient member 15 and is connected to the anode electrode 9 via the extraction wiring 36. Note that the resilient member 15 also can be directly connected to the anode electrode 9 or the electrode terminal 12 also can be directly connected to the anode electrode 9 without providing the extraction wiring 36. In this manner, an electrical connection between the anode electrode 9 and the electrode terminal 12 can be directly or indirectly attained. On the outer surface 4a of the second substrate 4, a connector 11 is fixed to an area 4b where the electron-emitting portion 10 is not formed at an inner surface side (a side of the first substrate 3) of the second substrate 4, and the cable 14 is electrically connected to the electrode terminal 12. The resilient member 15 is subjected to the compression force when forming the airtight container by bonding the first substrate 3 and the second substrate 4 each other via the frame member 5 interposed between these substrates, and both ends of the resilient member 15 are respectively pressed by the electrode terminal 12 and the extraction wiring 36. The anode electrode 9 provided inside the airtight container 2 in this manner is sequentially connected to the extraction wiring 36, the resilient member 15, the electrode terminal 12, the connector 11 and the cable 14, and the potential from the power supply 13 provided outside the airtight container 2 can be supplied to the anode electrode 9.

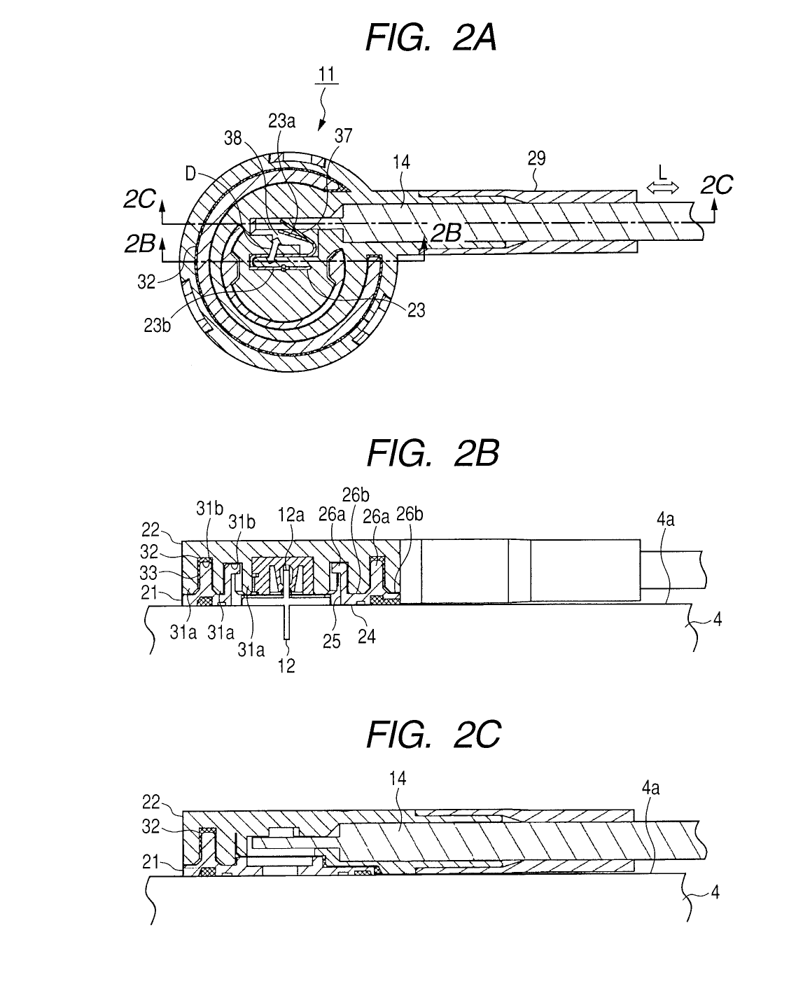

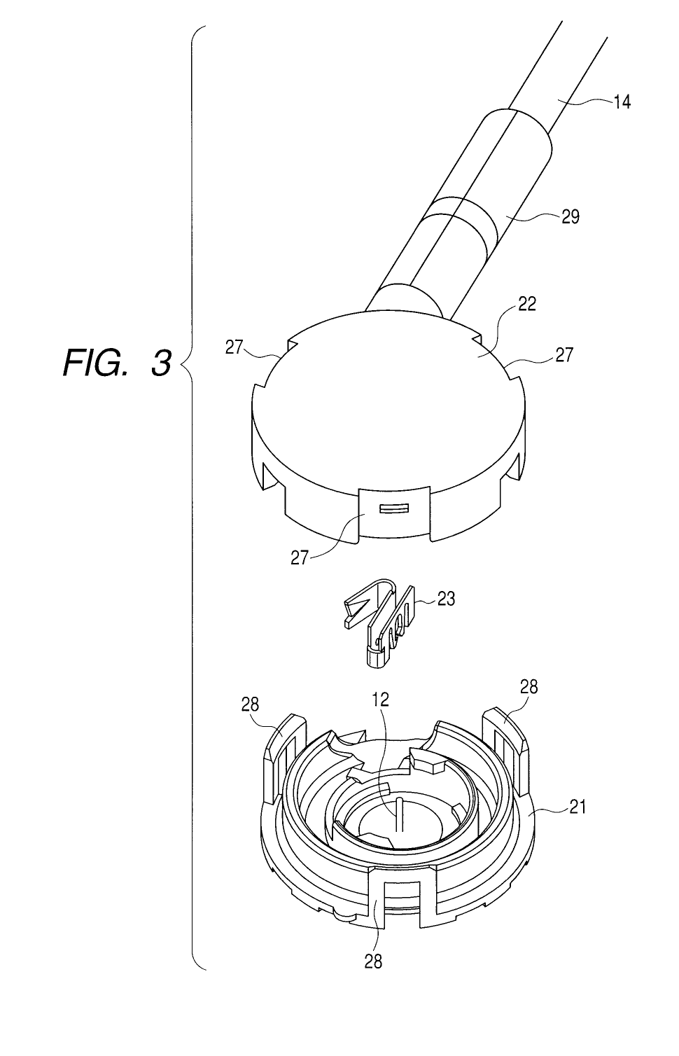

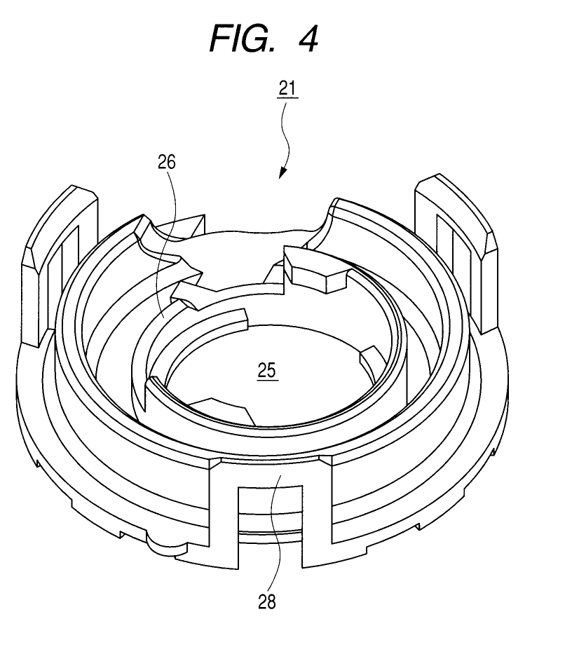

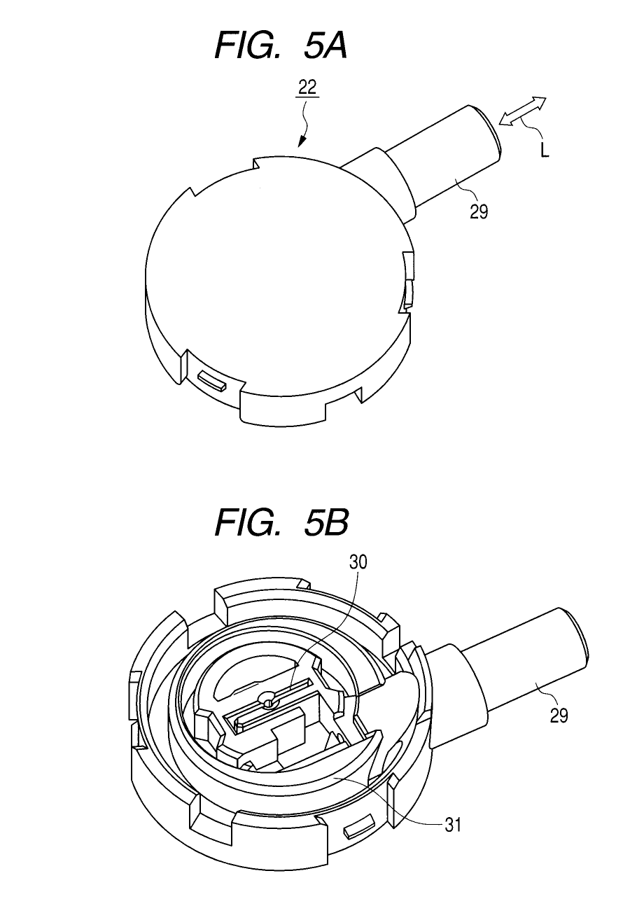

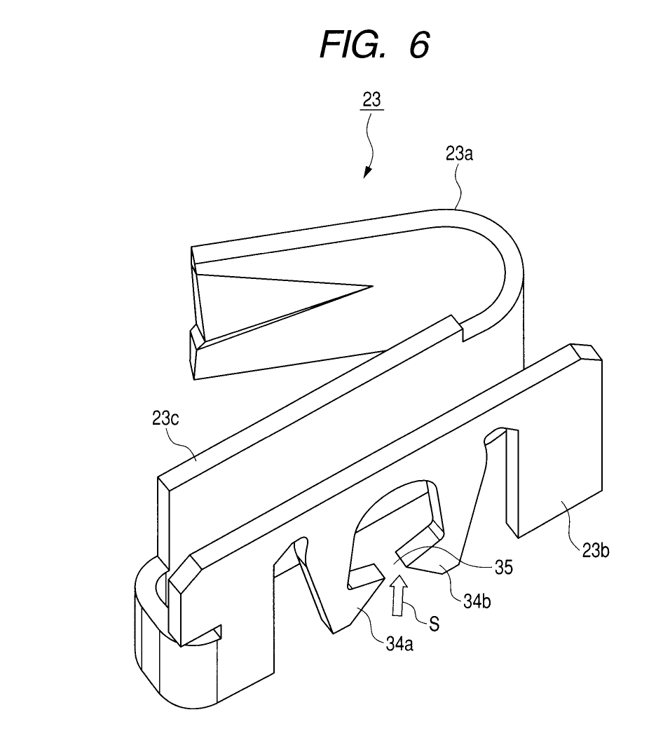

Next, the structure of the connector will be described in detail with reference to FIGS. 2A, 2B, 2C, 3, 4, 5A, 5B and 6. FIGS. 2A, 2B and 2C are the cross sectional views of the connector fixed to the airtight container. More specifically, FIG. 2A is the longitudinal cross-sectional view of the connector, FIG. 2B is the lateral cross-sectional view along the 2B-2B line in FIG. 2A, and FIG. 2C is the lateral cross-sectional view along the 2C-2C line in FIG. 2A. FIG. 3 is the disassembled perspective view of the connector. FIGS. 4, 5A, 5B and 6 are respectively the perspective views of a base member, a cap member and a conductive member which are serving as constitutional components of the connector. More specifically, FIG. 5A is the perspective view indicating the outer side of the cap member, and FIG. 5B is the perspective view indicating the inner side of the cap member.

The connector 11 has at least a base member 21 fixed to the outer surface 4a of the airtight container 2, a cap member 22 fixed to the base member 21 and a conductive member 23 held between the base member 21 and the cap member 22. The base member 21 is fixed to the outer surface 4a of the airtight container 2 (an atmospheric side surface of the second substrate 4) by adhering to the outer surface 4a by using, for example, an adhesive.

A base member 21 is composed of an insulation member such as PBT (PolyButylene Terephthalate) resin. In an example mentioned here, a configuration that the base member 21 is in contact with the outer surface 4a of the airtight container 2 at a bottom surface 24 of the base member 21 will be described. Therefore, in the example to be mentioned here, the bottom surface 24, which is a surface to be opposite to the outer surface 4a of the airtight container 2, becomes a contact surface to be in contact with the outer surface 4a of the airtight container 2. However, the bottom surface 24 of the base member 21 is not always required to be in contact with the second substrate 4. In this case, it is allowed to be fixed to the second substrate 4 in such a way that the bottom surface 24 of the base member 21 becomes parallel to an atmospheric side surface (the outer surface 4a of the airtight container 2) of the second substrate 4. A part of the electrode terminal 12 penetrates an aperture 25 provided at the contact surface 24, and a pointed end 12a of the electrode terminal 12 extends to the inside of the base member 21. The base member 21 has a first groove/rib structure 26 extending on a periphery around the conductive member 23 on such the position apart from the conductive member 23 as illustrated in FIGS. 2A, 2B and 2C and FIG. 4. The first groove/rib structure 26 has plural concentric ribs structure 26a extending on almost the whole periphery around the conductive member 23 except a portion where the cable 14 is inserted and plural concentric grooves 26b interposed between the plural ribs structure 26a. As illustrated in FIG. 3, plural projections 28 to be snap-engaged with notch portions 27 provided on an outer circumference of the cap member 22 are formed on an outer circumference of the base member 21.

The cap member 22, which is composed of the insulation member such as the PBT resin or the like similar to a case of the base member 21, has a cable insertion portion 29, where one end of the cable 14 is inserted. The cable insertion portion 29 is a cylindrical aperture formed that the extending direction of the cable 14 coincides with a longitudinal direction L of the cable insertion portion 29. A conductive member holding groove 30 for holding the conductive member 23 is provided inside the cap member 22. A second groove/rib structure 31 extending on a periphery around the conductive member 23 on such the position apart from the conductive member 23 is also provided in the cap member 22 similar to a case of the base member 21. The second groove/rib structure 31 also has plural concentric ribs structure 31a extending on almost the whole periphery around the conductive member 23 except a portion where the cable 14 is inserted and plural concentric grooves 31b interposed between the plural ribs structure 31a. The ribs 26a of the first groove/rib structure 26 are interdigitated with the grooves 31b of the second groove/rib structure 31 each other, and a gap 33 between the first groove/rib structure 26 and the second groove/rib structure 31, which are interdigitated with each other, is sealed by an insulator 32 composed of the silicon adhesive. Herewith, the cap member 22 is fixed to the base member 21, and it can be prevented that a water droplet to be formed by the dew condensation or the like flows into the gap 33 between the first groove/rib structure 26 and the second groove/rib structure 31. Therefore, it is not required to provide many ribs structure concentrically in order to lengthen the creepage distance, and the sufficient insulation performance can be ensured by only providing two or three-column ribs structure as illustrated in the drawings. In order to further improve the insulation performance, the first groove/rib structure 26 and the second groove/rib structure 31 can be also coated by the water-shedding resin composed of the polybutylene terephthalate or the like. In addition, according to the interdigitated structure by such the grooves and ribs, the positioning of the cap member 22 to the base member 21 becomes easy.

The resilient member 15 has to intersect the internal space 6 within the airtight container 2 in order to connect the electrode terminal 12 at a side of the second substrate 4 to the anode electrode 9 at a side of the first substrate 3 by the resilient member 15 as mentioned above. However, since a space 6a between the anode electrode 9 and the electron-emitting portion 10 is to serve as an electron moving space, the resilient member 15 can not be provide in this space 6a. Therefore, the connector 11 is located in an area 4b where the electron-emitting portion 10 of the second substrate 4 is not provided. However, in order to downsize an image displaying apparatus, the area other than an image display area (a projection area to the first substrate 3 in the space 6a) occupying the airtight container, that is, the area of periphery of the airtight container which does not contribute to display an image has to be reduced. For this reason, the reduction of plane size of the connector becomes important. To reduce the number of rib columns leads to reduction of the plane size of the connector and eventually leads to a great advantage of reducing the overall size of the image displaying apparatus.

The conductive member 23, which has almost an S-shaped (or Z-shaped) cross-section form, is inserted into the conductive member holding groove 30 similarly formed into an S-shaped form. Herewith, the conductive member 23 is held between the base member 21 and the cap member 22. The conductive member 23 has a first portion 23a to be in contact with the inserted cable 14, a second portion 23b to be in contact with the pointed end 12a of the electrode terminal 12 and a third portion 23c which positions between the first portion 23a and the second portion 23b. The S-shaped cross section of the conductive member 23 extends within a plane almost parallel to the contact surface 24. That is, the first portion 23a and the second portion 23b locate on positions mutually displaced to the direction D which is parallel to the contact surface 24.

The conductive material 23 is composed of a resiliently deformable conductive material such as the tinned copper alloy, and the first portion 23a is excursed within a plane parallel to the contact surface 24 by the inserted cable 14. An end of the first portion 23a, which is a free end, is in contact with the cable 14 by the resilient restoring force of the conductive member 23 generated by the excursion. That is, the first portion 23a is almost orthogonal to the longitudinal direction L and is excursed to the direction which comes close to the third portion 23c toward a retreat space 38, which is adjacent to the cable insertion portion 29, from an initial position 37 within the cable insertion portion 29 by the insertion of the cable 14 (refer to FIG. 2A). The first portion 23a is in contact with the cable 14 by the reactive force, which acts to return to the initial position 37 and operates to the direction of receding from the third portion 23c. Incidentally, if describing in detail, since the cable 14 is constituted that a conductive core wire such as the tinned copper alloy or the like is coated by the insulator, the core wire of the cable 14 is in contact with the first portion 23a of the conductive member 23. Therefore, the electrical connection between the conductive member 23 and the cable 14 is automatically performed by only inserting the cable 14 into the cable insertion portion 29. As a result, the simple and assured electrical connection is to be realized.

The second portion 23b has a pair of hooked portions 34a and 34b opened toward the insertion direction S of the electrode terminal 12. The pointed end 12a of the electrode terminal 12 is inserted into a space 35 between the hooked portions 34a and 34b so that the hooked portions 34a and 34b are opened each other. Consequently, the resilient restoring force due to the insertion of the electrode terminal 12 is generated in the hooked portions 34a and 34b. The pointed end 12a of the electrode terminal 12 receives the force acting to the inward direction from the hooked portions 34a and 34b by that resilient restoring force, and the pointed end 12a comes to be in contact with the hooked portions 34a and 34b and electrically connected with the hooked portions 34a and 34b. In this manner, the electrical connection between the conductive member 23 and the electrode terminal 12 is automatically performed by only inserting the electrode terminal 12 into the hooked portions 34a and 34b. As a result, the simple and assured electrical connection is to be realized similar to a case in the first portion 23a.

The second portion 23b is inserted into the conductive member holding groove 30. As mentioned above, since the electrode terminal 12 is inserted into the hooked portions 34a and 34b, a portion of the conductive member holding groove 30, where the second portion 23b is inserted, has such the width capable of inserting the electrode terminal 12. Consequently, a portion of the conductive member holding groove 30, where the second portion 23b is inserted, is formed to become wider than the width of the second portion 23b. A semispherical projection or a semi-columnar projection (not illustrated) vertically extending to the contact surface 24 is provided on a portion in the vicinity of the hooked portions 34a and 34b of the second portion 23b, and it is allowed that the projection comes to be in contact with a wall surface of the conductive member holding groove 30 and the second portion 23b performs a pivoting motion centering around the projection.

The third portion 23c, which corresponds to a central portion of the S-shaped form, is firmly fixed so as to engage with the conductive member holding groove 30. As mentioned above, since the one end (the first portion 23a) of the conductive member 23 is a free end and the other end (the second portion 23b) is held to be able to displace or to perform the pivoting motion in the conductive member holding groove 30, the conductive member 23 is fixed to the cap member 22 by the third portion 23c.

As described above, in the present embodiment, since the first portion 23a and the second portion 23b of the conductive member 23 are located on different positions each other within the same plane parallel to the contact surface 24, the electrical connection between the electrode terminal 12 and the cable 14 can be realized within a plane almost parallel to the contact surface. Since the conventional connector realized the electrical connection between the electrode terminal and the cable in the direction orthogonal to the contact surface, height of the connector protruding from an outer surface of the second substrate inevitably tended to become larger, however the protruding height of the connector 11 of the present embodiment can be easily reduced.

In addition, since a gap between the first groove/rib structure 26 and the second groove/rib structure is infilled with the insulator, it can be easily prevented to flow a water droplet to be formed by the dew condensation or the like into the gap, the insulation strength is improved and the insulation can be easily ensured without sufficiently saving the creepage distance at the same time. Conventionally, in order to save the creepage distance, the planar extent and height of the first groove/rib structure 26 and the second groove/rib structure 31 had to be sufficiently saved, and this fact contributed to the large size of the connector, however the connector can be easily downsized in the present embodiment. As an example, the diameter and height of the connector based on the prior art were respectively 26 mm and 15 mm. However, in the present embodiment, the diameter and height were respectively reduced to 20 mm and 8 mm.

The above-described exemplary embodiments merely indicate examples of concretization in the case where the present invention is carried out. That is, it is to be understood that the technical scope of the present invention should not be limited to the disclosed exemplary embodiments. For example, it is possible to properly combine the respective embodiments mutually. In other words, it is possible to carry out the present invention in various forms without departing from the technical idea or the main features thereof.

This application claims priority from Japanese Patent Application No. 2009-061341 filed on Mar. 13, 2009, which is hereby incorporated by reference herein in its entirety.

What is claimed is:

1. An image displaying apparatus comprising:
an airtight container;
an electrode terminal which penetrates an outer surface of the airtight container and is adapted to supply potential to an electrode provided inside the airtight container;
a cable which has a portion extending along the outer surface of the airtight container and is connected to a power supply generating the potential; and
a connector which is fixed to the outer surface of the airtight container and is adapted to connect the cable and the electrode terminal to each other, wherein
the connector comprises
a base member which is fixed to the outer surface of the airtight container, and in which a part of the electrode terminal penetrates an aperture provided on a bottom surface of the base member opposite to the outer surface of the airtight container and a pointed end of the electrode terminal extends up to an inside of the base member,
a cap member which has a cable insertion portion in which one end of the cable has been inserted, and is fixed to the base member, and
a conductive member which includes a first portion held between the base member and the cap member and being in contact with the inserted cable and a second portion being in contact with the pointed end of the electrode terminal, and
the first portion and the second portion are positioned separately on a same plane which is in parallel with the bottom surface.

2. The image displaying apparatus according to claim 1, wherein
the base member includes a first groove/rib structure having grooves and ribs extending around the conductive member at respective positions apart from the conductive member,
the cap member includes a second groove/rib structure having grooves and ribs extending around the conductive member at respective positions apart from the conductive member and interdigitating the first groove/rib structure, and
a gap between the first groove/rib structure and the second groove/rib structure interdigitating each other is sealed by an insulator.

3. The image displaying apparatus according to claim 1, wherein
the conductive member is made by a resiliently deformable material,
the first portion is excursed in a plane being in parallel with the bottom surface by the inserted cable, and is in contact with the cable by resilient restoring force of the conductive member generated by the excursion of the first portion, and
the second portion has a pair of hooked portions opening toward an insertion direction of the electrode terminal, the pointed end of the electrode terminal is inserted so that the hooked portions open, and the second portion is in contact with the pointed end of the electrode terminal by resilient restoring force of the hooked portions generated by the insertion of the electrode terminal.

4. The image displaying apparatus according to claim 3, wherein
the cable insertion portion is a cylindrical aperture portion of which a longitudinal direction coincides with a direction in which the cable extends, and
the first portion is excursed, in a direction perpendicular to the longitudinal direction, from an initial position inside the cable insertion portion to a retreat space adjacent to the cable insertion portion by the insertion of the cable.

5. The image displaying apparatus according to claim 1, wherein
the airtight container includes a first substrate and a second substrate which are arranged oppositely through an internal space which is interposed between these substrates and maintained with a pressure lower than an atmospheric pressure,
the first substrate has an anode electrode,
the second substrate has an electron-emitting portion,
on the second substrate, the connector is fixed to a region where the electron-emitting portion is not formed, and
the electrode terminal is connected to the anode electrode through a conductive resilient member intersecting the internal space.
